(19) United States
(12) Patent Application Publication
(10) Pub. No.: US 2017/0108958 A1
(43) Pub. Date: Apr. 20, 2017

(54) CAPACITIVE STYLUS WITH BALL

(71) Applicant: WALTOP INTERNATIONAL CORPORATION, Hsinchu City (TW)

(72) Inventors: CHIA-JUI YEH, Taipei City (TW); A-Li Wong, Hsinchu City (TW)

(21) Appl. No.: 14/932,690

(22) Filed: Nov. 4, 2015

(30) Foreign Application Priority Data
Oct. 19, 2015 (TW) 104216711

(51) Int. Cl. G06F 3/0354

(52) U.S. Cl. CPC G06F 3/03546

(57) ABSTRACT

A capacitive stylus, as an inputting device of a touch sensitive device, comprises a ball, a ball circuit, a signal-emitting unit, a control circuit, and a battery. The ball circuit comprises a pair of sensing units respectively arranged at up and down side of the ball for tracking the rolling of the ball. The signal-emitting unit emits a signal to the touch sensitive device according to the tracking of the ball. The control circuit electrically connects with the ball circuit and the signal-emitting unit. The battery provides electricity to the control circuit.

### CROSS-REFERENCE TO RELATED APPLICATIONS

The entire contents of Taiwan Patent Application No. 104216711, filed on Oct. 19, 2015, from which this application claims priority, are expressly incorporated herein by reference.

### BACKGROUND OF THE INVENTION

1. Field of the Invention

The present invention relates to an inputting device, and more particularly relates to a capacitive stylus with a ball.

2. Description of Related Art

Touch sensitive devices are becoming increasingly popular because of their ease and versatility of operation. A touch sensitive device can generally allow a user to perform various functions by touching or hovering over its panel using one or more fingers. The touch sensitive device recognizes a touch event and the position of the touch event on the panel, and then interprets the touch event, and thereafter performs one or more operations based on the touch event.

Dictating by one or more fingers, however, may be inconvenient or limited for some situations and people. For example, writing on the screen by one or more fingers may be inconvenient for some people. In addition, the pressure of the finger exerted on the screen of the touch sensitive device cannot be measured. Further, when viewing a document, a picture or a website displayed on the screen of the touch sensitive device, the document, picture, or website may be too large to be displayed in its entirety on the displaying area of the touch sensitive device, then the user must use the stylus to move the document, picture, or website to see other portions that are off-screen.

A need is therefore arisen to provide a capacitive stylus for helping the user to operate the touch sensitive device.

### SUMMARY OF THE INVENTION

In one general aspect, the present invention relates to a capacitive stylus with a ball allowing the user to more conveniently operate a touch sensitive device.

In an embodiment of the present invention, a capacitive stylus is provided as an inputting device of a touch sensitive device. The capacitive stylus comprises a ball, a ball circuit, a signal-emitting unit, a control circuit, and a battery. The ball circuit comprises a first pair of sensing units respectively arranged near to the upside and downside of the ball for tracking the upward and downward movements of the ball. The signal-emitting unit is used for emitting a high voltage signal based on an operation of the ball. The control circuit generates the high voltage signal and electrically connects with the ball circuit and the ball circuit. The battery provides electivity to the control circuit.

In an embodiment, the signal-emitting unit comprises a tip, a force sensor, a spring, and a sheath.

In an embodiment, the force sensor electrically connects with the control circuit via a flexible printed circuit board, a front end of the tip has a protection, a rear end of the tip passes through the sheath, and the tip can contact the force sensor through the sheath.

In an embodiment, a front end of the spring winds around a portion of the sheath, and a rear end of the spring connects with the control circuit.

In an embodiment, each of the first pair of sensing units comprises a first roller, a first Hall sensing element, a first switch comprising an input terminal, an ON terminal, and an OFF terminal, and a first capacitor comprising an input terminal and an output terminal, wherein the first roller contacts with the ball, the first Hall sensing element is arranged near to the first roller but not contacts with the first roller, the first Hall sensing element connects to the input terminal of the first switch, the ON terminal of the first switch connects to the input terminal of the first capacitor, and the output terminal of the first capacitor connects to the control circuit.

In an embodiment, the first switch comprises a digital switch.

In an embodiment, the first roller is a ring-shaped magnet.

In an embodiment, the ball circuit further comprises a mechanical switch arranged below the ball, a switch is connected in series with the mechanical switch between the ball and the control circuit, and when the user presses the ball, the mechanical switch triggers the switch to an open position, so that the control circuit emits a high voltage through the signal-emitting unit to the touch sensitive device.

In an embodiment, when the user presses the ball, the touch sensitive device provides an event to the user, and the event comprises a context menu for the user choosing.

In an embodiment, the ball circuit further comprises a second pair of sensing units respectively arranged near the left and right side of the ball for detecting the left and right movements of the ball.

### BRIEF DESCRIPTION OF THE DRAWINGS

FIG. 1 is a block diagram showing a capacitive stylus according to an embodiment of the present invention.

FIG. 2 is a perspective view showing a capacitive stylus according to an embodiment of the present invention.

FIG. 3 is a perspective view showing the major components of a capacitive stylus according to an embodiment of the present invention.

FIG. 4 is a block diagram illustrating the detail of the ball circuit of FIG. 1.

FIG. 5 shows a typical voltage signal outputted from a Hall sensing element according to an embodiment of the present invention.

### DETAILED DESCRIPTION OF THE PREFERRED EMBODIMENT

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations and components are not been described in detail in order not to unnecessarily obscure the present invention. While drawings are illustrated in details, it is appreciated that the quantity of the disclosed components may be greater or less than that disclosed, except expressly restricting the amount of the components. Wherever possible, the same or similar reference numbers are used in drawings and the description to refer to the same or like parts.

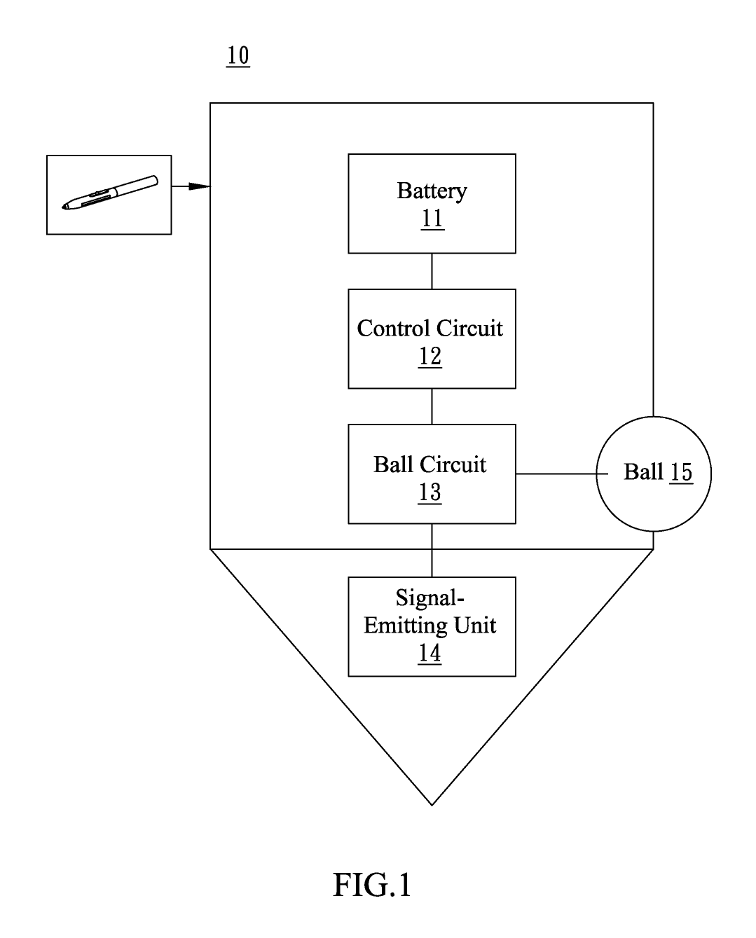

FIG. 1 is a block diagram showing a capacitive stylus 10 according to an embodiment of the present invention. Preferably, the capacitive stylus 10 is used as an inputting device of a touch sensitive device (not shown), such as a mobile phone, a tablet personal computer, or the likes.

Referring to FIG. 1, the capacitive stylus 10 comprises a battery 11, a control circuit 12, a ball circuit 13, a signal-emitting unit 14, and a ball 15. The battery 11 provides electricity to the control circuit 12 and/or the ball circuit 13. The touch sensitive device may include a touch screen or include in-cell photo sensors, so that the touch events and touch positions of the user can be detected. In an embodiment of the present invention, the touch sensitive device includes, but is not limited to, a capacitive touch screen. The ball 15 assists the user to operate the touch sensitive device, and the configuration of the ball 15 may be similar to the configuration of a track ball or a jog ball.

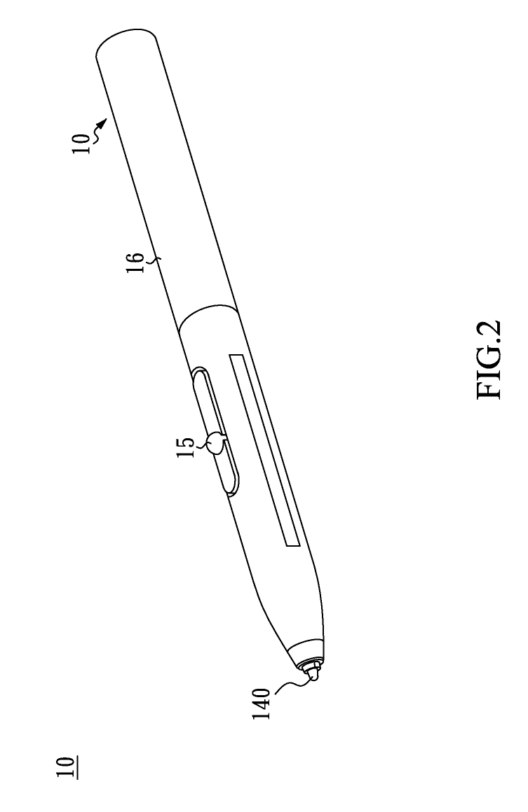

FIG. 2 is a perspective view showing a capacitive stylus 10 according to an embodiment of the present invention. Referring to FIG. 2, the capacitive stylus 10 comprises a housing 16, and a portion of the ball 15 and a portion of a tip 140 is uncovered by the housing 16.

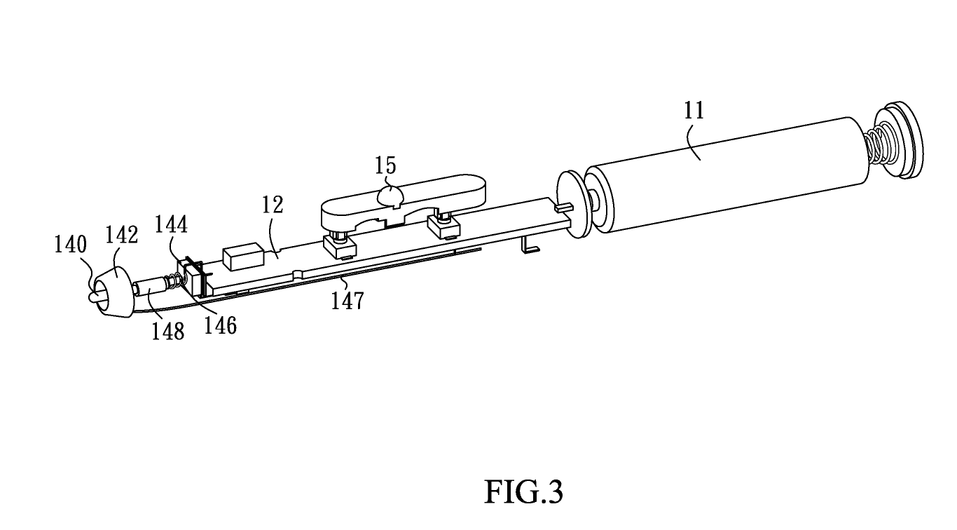

FIG. 3 is a perspective view showing the major components of a capacitive stylus 10 according to the present invention. Referring to FIG. 3, the signal-emitting unit 14 may comprise, but is not limited to, a tip 140, a metal cap 142, a force sensor 144, a spring 146, a wire 147, and a sheath 148. The force sensor 144 may be welded on a flexible printed circuit board (not shown), which electrically connects with the control circuit 12. A front end of the tip 140 may have a protection (not shown), and a rear end or a rear portion of the tip 140 may be arranged within or may pass through a sheath 148. The tip 140 may contact the force sensor 144 through the sheath 148. In addition, a front end of the spring 146 winds around a portion of the sheath 148, and a rear end of the spring 146 connects with the control circuit 12. The spring 146 can provide a force to push the sheath 148 back to its original position. The metal cap 142 electrically connects with the control circuit 12 through the wire 147, and may be used for estimating the position of the capacitive stylus 10 by sensing and/or introducing induction with the sensing electrodes of the touch sensitive device. The force sensor 144 electrically connects with the control circuit 12. When the tip 140 contacts the force sensor 144 via the sheath 148, the force sensor 144 will output a voltage or a current to the control circuit 12, and the control circuit 12 comprises a micro control unit (not shown) that can estimate the force exerted on the screen of the touch sensitive device according to the voltage or current. Based on the estimated force, the control circuit 13 may emit a high voltage signal via the metal cap 142 through the wire 147, and the touch sensitive device receives the high voltage signal and performs one or more operations, such as a performing a handwriting with a degree of thickness based on the received signal. Alternatively, the spring 146 may electrically connect with the control circuit 12, and the control circuit 12 may emit the high voltage signal via the spring 146 and/or the tip 140, so that the touch sensitive device receives the high-voltage signal and performs one or more operation based on the high voltage signal.

Notice that in another embodiment of the present invention, the signal-emitting unit 14 can also function a signal-receiving unit to receive signals from the touch sensitive device.

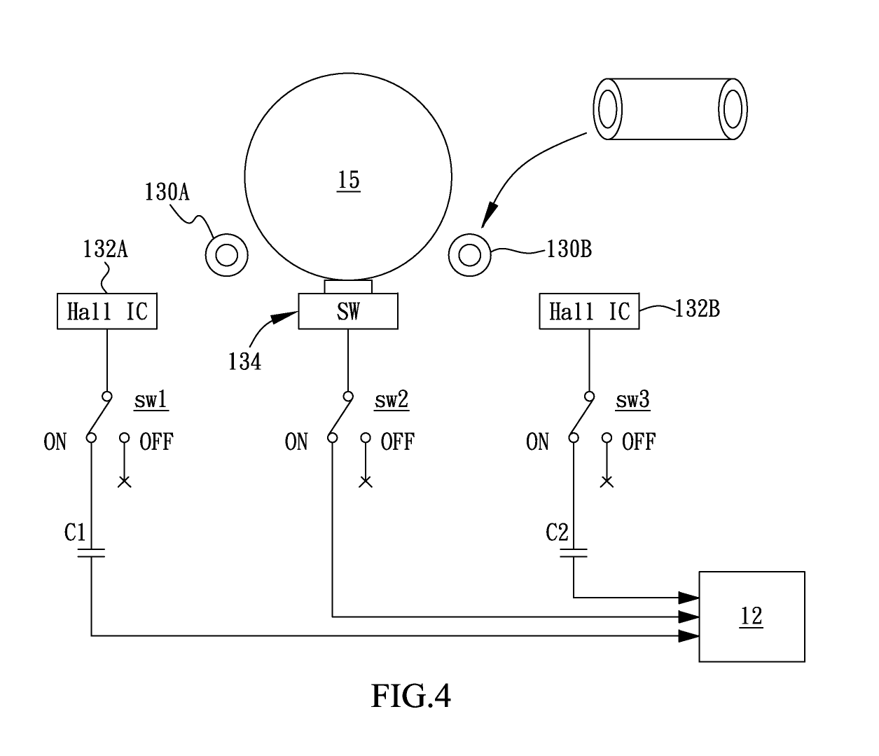

FIG. 4 is a block diagram illustrating a detail of ball circuit 13 of FIG. 1. The ball circuit 13 comprises a pair of rollers 130A and 130B arranged near to the upside and downside of the ball 15 (the capacitive stylus 10 being stood vertically as the reference direction) and in contact with the ball 15. In this embodiment, the rollers 130A and 130B may have, but is not limited to, a ring-shaped configuration and comprise a magnetic material, such as magnet. A Hall sensing element (Hall Effect IC) 132A is arranged near to the roller 130A but not contacts with the roller 130A. A Hall sensing element 132B is arranged near to the roller 130B but not contacts with the roller 130B. Hall sensing element 132A and the roller 130A built a sensing unit for detecting whether the ball 15 is moved upwardly. Hall sensing element 132B and the roller 130B built a sensing unit for detecting whether the ball 15 is moved downwardly. A switch SW1 is connected in series with a capacitor C 1 between the Hall sensing element 132A and the control circuit 12. A switch SW3 is connected in series with a capacitor C2 between the Hall sensing element 132B and the control circuit 12. In addition, as show in FIG. 4, a mechanical switch 134 is arranged below the ball 15 (the stylus 10 being horizontally arranged as the reference direction) and a switch SW2 is connected in series with the control circuit 12. In one embodiment, the switch SW1, SW2, and SW3 may be, but is not limited to, digital switch. In another embodiment, the mechanical switch 134 and the switch SW2 are omitted.

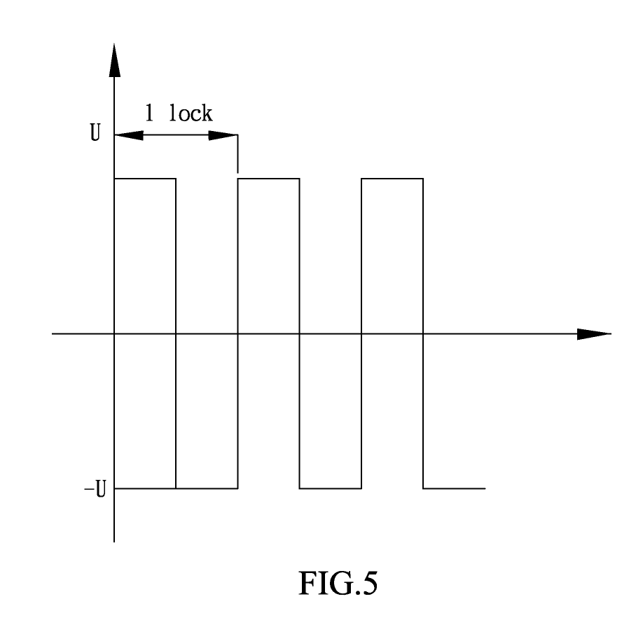

Referring to FIG. 4, when the user rolls the ball 15, for example, rolling the ball 15 upwardly, the roller 130A will be rolled simultaneously. The rolling of the roller 130A varies the magnetic field and Hall sensing element 132A generates voltage signal. A typical voltage signal is exemplarily shown in FIG. 5. Referring to FIG. 5, the voltage signals outputted from Hall sensing element 132A are ranged from −U to U. One voltage signal U and one voltage −U construct one clock. When the ball 15 rolls one circle, the Hall sensing element 132 will output a constant number of clocks. Accordingly, the upward displacement of the ball 15 can be calculated by counting the clocks. The same principle also is employed for the case of the ball 15 rolling downwardly, and the description of which is omitted. In addition, the switch SW1 and SW3 is operated to an “ON” or “OFF” position according to an upper limit voltage. Taking switch SW1 as the example, when the voltage outputted from the Hall sensing element 132A is higher than the upper limit voltage, the switch SW1 is operated to the “ON” position; otherwise the switch SW1 is operated to the “OFF” position. For example, when the highest voltage outputted from the Hall sensing element is 3.3V, the upper limit voltage may be determined as 2.5V. When the switch SW1 is operated to the “ON” position, the capacitor C1 is connected to the control circuit 12, and the control circuit 12 will emit a high voltage signal to the touch sensitive device. Accordingly, the touch sensitive device is aware that the ball 15 is rolled upwardly and performs a corresponding operation, e.g., moving a picture or a website downwardly for a predetermined distance. The same principle is also applied to the case that the ball 15 is rolled downwardly. When the ball 15 is rolled downwardly, the switch SW3 is operated to the “ON” position and the capacitor C2 is connected to the control circuit 12, and the control circuit 12 will emit a voltage signal to the touch sensitive device. Accordingly, the touch sensitive device is aware that the ball 15 is rolled downwardly and performs a corresponding operation, e.g., moving upwardly a picture or a website for a predetermined distance.

Referring to FIG. 4, when the user presses the ball 15, the mechanical switch 134 triggers the switch SW2 to the “ON” position, and the control circuit 12 will emit a high voltage signal to the touch sensitive device. Accordingly, the touch sensitive device is aware that the ball 15 is pressed and may provide a response to the user. In one embodiment, the user presses the ball 15 will trigger an event same as that trigged by the right-click of a typical mouse device.

Moreover, another embodiment of the present invention further comprises another pair of sensing units (not shown), wherein one sensing unit comprises one roller and one Hall sensing element and this pair of sensing units are employed for detecting the movement of the ball 15 in another direction, for example, the left and right movement of the ball 15. The structure of this pair of sensing unit may be same as that of FIG. 4, a switch (not shown) being connected in series with a capacitor (not shown) between the Hall sensing element and the control circuit 12. The structure and operation are same as that of FIG. 4; therefore the description of which are omitted.

Referring to FIGS. 2 and 4, the rollers 130A/B and the Hall sensing element 132A/B, and a portion of the ball 15 may be covered by the housing 16. The user can move the displaying image in upward, downward, rightward, and leftward directions by rolling the ball 15. For example, when the touch sensitive device is displaying a web page, the up, down, left, and right rolling of the ball 15 corresponds to use the up, down, left, and right scroll bars of a browser to move the displaying web page. In addition, the user pressing the ball 15 may result that the touch sensitive device provides a context menu for selection by the user.

The intent accompanying this disclosure is to have each/all embodiments construed in conjunction with the knowledge of one skilled in the art to cover all modifications, variations, combinations, permutations, omissions, substitutions, alternatives, and equivalents of the embodiments, to the extent not mutually exclusive, as may fall within the spirit and scope of the invention. Corresponding or related structure and methods disclosed or referenced herein, and/or in any and all co-pending, abandoned or patented application(s) by any of the named inventor(s) or assignee(s) of this application and invention, are incorporated herein by reference in their entireties, wherein such incorporation includes corresponding or related structure (and modifications thereof) which may be, in whole or in part, (i) operable and/or constructed with, (ii) modified by one skilled in the art to be operable and/or constructed with, and/or (iii) implemented/made/used with or in combination with, any part(s) of the present invention according to this disclosure, that of the application and references cited therein, and the knowledge and judgment of one skilled in the art.

Conditional language, such as, among others, “can,” “could,” “might,” or “may,” unless specifically stated otherwise, or otherwise understood within the context as used, is generally intended to convey that embodiments include, and in other interpretations do not include, certain features, elements and/or steps. Thus, such conditional language is not generally intended to imply that features, elements and/or steps are in any way required for one or more embodiments, or interpretations thereof, or that one or more embodiments necessarily include logic for deciding, with or without user input or prompting, whether these features, elements and/or steps are included or are to be performed in any particular embodiment.

All of the contents of the preceding documents are incorporated herein by reference in their entireties. Although the disclosure herein refers to certain illustrated embodiments, it is to be understood that these embodiments have been presented by way of example rather than limitation. For example, any of the particulars or features set out or referenced herein, or other features, including method steps and techniques, may be used with any other structure(s) and process described or referenced herein, in whole or in part, in any combination or permutation as a non-equivalent, separate, non-interchangeable aspect of this invention. Corresponding or related structure and methods specifically contemplated and disclosed herein as part of this invention, to the extent not mutually inconsistent as will be apparent from the context, this specification, and the knowledge of one skilled in the art, including, modifications thereto, which may be, in whole or in part, (i) operable and/or constructed with, (ii) modified by one skilled in the art to be operable and/or constructed with, and/or (iii) implemented/made/used with or in combination with, any parts of the present invention according to this disclosure, include: (I) any one or more parts of the above disclosed or referenced structure and methods and/or (II) subject matter of any one or more of the inventive concepts set forth herein and parts thereof, in any permutation and/or combination, include the subject matter of any one or more of the mentioned features and aspects, in any permutation and/or combination.

Although specific embodiments have been illustrated and described, it will be appreciated by those skilled in the art that various modifications may be made without departing from the scope of the present invention, which is intended to be limited solely by the appended claims.

1. A capacitive stylus as an inputting device of a touch sensitive device, the capacitive stylus comprising:
a ball;
a ball circuit comprising a first pair of sensing units respectively arranged near to the upside and downside of the ball, for tracking the upward and downward movements of the ball;
a signal-emitting unit for emitting a high voltage signal based on an operation of the ball, wherein the signal-emitting unit comprises:
a tip having a rear end and a front end for writing on a surface of the touch sensitive device;
a sheath through which the rear end of the tip passes;
a force sensor being vertically pressed and being in contact with the sheath in response to the tip being pressed against the surface of the touch sensitive device; and
a spring being disposed between the sheath and the force sensor;
a control circuit generating the high voltage signal and electrically connecting with the ball circuit, the force sensor electrically connecting with the control circuit via a flexible printed circuit board; and
a battery providing electivity to the control circuit.

2-3. (canceled)

4. The capacitive stylus of claim 1, wherein a front end of the spring winds around a portion of the sheath, and a rear end of the spring connects with the control circuit.

5. The capacitive stylus of claim 1, wherein each of the first pair of sensing units comprises a first roller, a first Hall sensing element, a first switch comprising an input terminal, an ON terminal, and an OFF terminal, and a first capacitor comprising an input terminal and an output terminal, the first roller contacts with the ball, the first Hall sensing element is arranged near to the first roller but not contacts with the first roller, the first Hall sensing element connects to the input terminal of the first switch, the ON terminal of the first switch connects to the input terminal of the first capacitor, and the output terminal of the first capacitor connects to the control circuit.

6. The capacitive stylus of claim 5, wherein the first switch comprises a digital switch.

7. The capacitive stylus of claim 5, wherein the first roller is a ring-shaped magnet.

8. The capacitive stylus of claim 1, wherein the ball circuit further comprises a mechanical switch arranged below the ball, a switch is connected in series with the mechanical switch between the ball and the control circuit, and when the user presses the ball, the mechanical switch triggers the switch to an open position, so that the control circuit emits a high voltage through the signal-emitting unit to the touch sensitive device.

9. The capacitive stylus of claim 8, wherein when the user presses the ball, the touch sensitive device provides an event to the user, and the event comprises a context menu for the user choosing.

10. The capacitive stylus of claim 1, wherein the ball circuit further comprises a second pair of sensing units respectively arranged near the left and right side of the ball for detecting the left and right movements of the ball.
